(19) United States
(12) Patent Application Publication
(10) Pub. No.: US 2023/0192104 A1
(43) Pub. Date: Jun. 22, 2023

(54) HYBRID SCENARIO CLOSED COURSE TESTING FOR AUTONOMOUS VEHICLES

(71) Applicant: GM CRUISE HOLDINGS LLC, SAN FRANCISCO, CA (US)

(72) Inventors: Nestor Grace, San Francisco, CA (US); Javier Fernandez Rico, Concord, CA (US); Dogan Gidon, Seattle, WA (US); Diego Plascencia-Vega, Berkeley, CA (US)

(21) Appl. No.: 17/558,000

(22) Filed: Dec. 21, 2021

(51) Int. Cl. B60W 50/02; B60W 40/02; B60W 60/00

(52) U.S. Cl. CPC B60W 50/02; B60W 40/02; B60W 60/001

(57) ABSTRACT

The present technology pertains to generating hybrid scenario information for use during closed course testing of an autonomous vehicle (AV). Such hybrid scenario information may be generated by combining sensor data from an AV, simulated environment information, simulated object information, and information obtained using perceivable marker information of a perceivable marker perceived by the AV in the closed course environment. The hybrid scenario information may be provided to the AV during the closed course testing. The AV may respond to the hybrid scenario information by performing one or more AV control actions.

### TECHNICAL FIELD

The subject matter of this disclosure relates in general to the field of autonomous vehicles, and more particularly, to systems and methods for improving closed course testing for Autonomous Vehicles (AVs) by using real sensor data, simulated data, and data obtained when perceivable markers are perceived by AVs.

### BACKGROUND

An Autonomous Vehicle (AV) is a motorized vehicle that can navigate without a human driver. The AV can include a plurality of sensor systems, such as a camera system, a Light Detection and Ranging (LIDAR) system, a Radio Detection and Ranging (RADAR) system, and so on. The AV may operate based upon sensor signal output of the sensor systems. For example, the sensor signals can be provided to a local computing system in communication with the plurality of sensor systems, and a processor can execute instructions based upon the sensor signals to control one or more mechanical systems of the AV, such as a vehicle propulsion system, a braking system, a steering system, and so forth.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of a system for managing one or more Autonomous Vehicles (AVs), in accordance with some aspects of the present technology;

FIG. 2 illustrates an example of a system for generating hybrid scenario information, in accordance with some aspects of the present technology;

FIG. 3 is a flowchart of a method for generating hybrid scenario information, in accordance with some aspects of the present technology;

FIG. 4 is a flowchart of a method for testing an AV in a closed course environment using hybrid scenario information, in accordance with some aspects of the present technology;

FIG. 5 shows an example of a scenario represented by hybrid scenario information, in accordance with some aspects of the present technology; and

FIG. 6 shows an example of a computing system for implementing certain aspects of the present technology.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

In general, embodiments described herein relate to systems, methods, and computer-readable media for hybrid closed course testing. Specifically, embodiments herein may combine real sensor data from an AV in a closed course environment, simulated scenario information, and/or information derived from perceivable markers perceived by an AV to generate hybrid scenario information for testing an AV in a closed course environment.

The AV may depend on geographic and spatial (geospatial) data to localize itself (e.g., obtain its position and orientation (pose)) and other objects within its immediate surroundings, determine routes towards destinations, and to coordinate motor controls to maneuver safely and efficiently while in transit, among other operations. The AV geospatial data can include the various dimensions or attributes (e.g., Global Positioning System (GPS) coordinates; polygon vertices; polyline vertices; length, width, height; radial distance, polar angle; etc.) of physical places and things (e.g., streets, lanes, crosswalks, sidewalks, medians, traffic signal poles, traffic signs, etc.). The AV geospatial data can also include abstract or semantic features (e.g., speed limits, carpool lanes, bike lanes, crosswalks, intersections, legal or illegal U-turns, traffic signal lights, etc.) that the AV can evaluate to determine the next set of actions it may take for a given situation. For example, an intersection tagged as a permissive left turn may indicate that it is legal for the AV to turn left on a solid green traffic signal light so long as the AV yields to any oncoming traffic (i.e., other objects). The annotation of locations, objects, and features can require at least some human intervention, such as the manual labeling of certain areas, physical things, or concepts; quality assurance review of computer-generated geospatial observations; computer-aided design of maps; and so on. In order to prepare an AV for navigating autonomously, a machine learning model may use information about one or more environments surrounding any number of AVs as input. Such input may allow the machine learning model to be trained to recognize, assess, and/or react to such environments. In order to improve AV response to environments, AVs are often tested.

When testing the AV on the road or a closed course, it may be difficult to create complex scenarios to test detailed responses of different AV subsystems. Specifically, on-road scenes may involve a multitude of different active traffic participants (e.g., pedestrians, bicycles, cars, motorcycles, buses, etc.) and environmental factors (e.g., different lane sizes, signs, obstructions, vegetation, etc.). It is challenging to accurately recreate such scenarios in a closed course testing, as it is difficult to manage multiple agents and have resources available to match the details of the various scenarios that AVs may encounter on the road. A detailed re-creation would require, for example, drawing different lane markers to represent different intersections, getting multiple pedestrians (or pedestrian-like agents) to move in specific directions at specific times, etc.

Testing complex AV systems can be particularly challenging due to the complexities of the various scenarios AVs encounter. In many cases, these scenarios are difficult to reproduce in closed-course testing due to the diversity of agents and environments that may be required. Thus, testing of complex AV scenarios is often done using computer implemented simulated scenarios (e.g., a scenario represented within a simulated computer environment). However, purely simulated scenarios may lack the detailed physics present in the real world. Additionally, AV testing is often not practical to conduct on actual roads with real traffic participants. Accordingly, there is value in testing AVs in physical reality such as a closed course environment.

In a closed course environment, the physics of the real world (e.g., vehicle dynamics, road imperfections, etc.), real sensor data (e.g., reflectivity of objects, etc.), and realistic AV hardware effects (e.g., latency, etc.) may be incorporated. As an example, there are times where the friction coefficient between a tire and the road, slight variations in latency (e.g., caused by hardware), the noisiness of sensor readings, etc., can be the difference between a safety critical situation and just a normal situation. For this reason, closed course testing can be very important in determining the quality and/or safety of an AV. However, performing closed course testing may require a significant amount of resources, manual labor, time, etc. For example, real cars have to be positioned in certain places, faux pedestrian motion needs to be driven by someone during the test, etc. This limits the amount of closed-course testing that can be done as it is expensive, labor intensive, and time consuming.

Embodiments described herein address the above-described and other deficiencies of closed course testing of AVs with a hybrid approach to closed-course testing. In one or more embodiments, part of a scenario provided to an AV may be simulated (e.g., purely simulated, based on previously recorded data, etc.) while the AV drives on a closed course. Such simulated scenario information may be combined with real-time perception information of the AV (e.g., from AV sensors). In one or more embodiments, the simulated scenario information and the information from the sensors of the AV may be augmented further by having one or more physical agents present in the closed course environment that have attached perceivable markers (e.g., Quick Response (QR) codes). When the AV perceives such perceivable markers, the perceivable markers may be used to perform a lookup in a data structure that maps the virtual markers to virtual objects that could exist in an environment surrounding an AV (e.g., other vehicles, pedestrians, etc.). The real sensor data, data derived using the perceivable markers on physical agents in the closed course environment, and simulated scenario information may be combined to generate hybrid scenario information. Such hybrid scenario information may be provided to one or more locations in the software stack (e.g., the perception stack, the localization stack, the prediction stack, the planning stack, the control stack, etc.) of the AV such that the AV subsystems respond to the hybrid scenario rather than solely to the physical environment of the closed course. Thus, a much greater quantity and variety of complex scenarios may be represented in closed-course testing of an AV, allowing for detailed testing of various AV subsystems while maintaining the benefits associated with testing the AV in physical reality (i.e., as opposed to pure computer simulation).

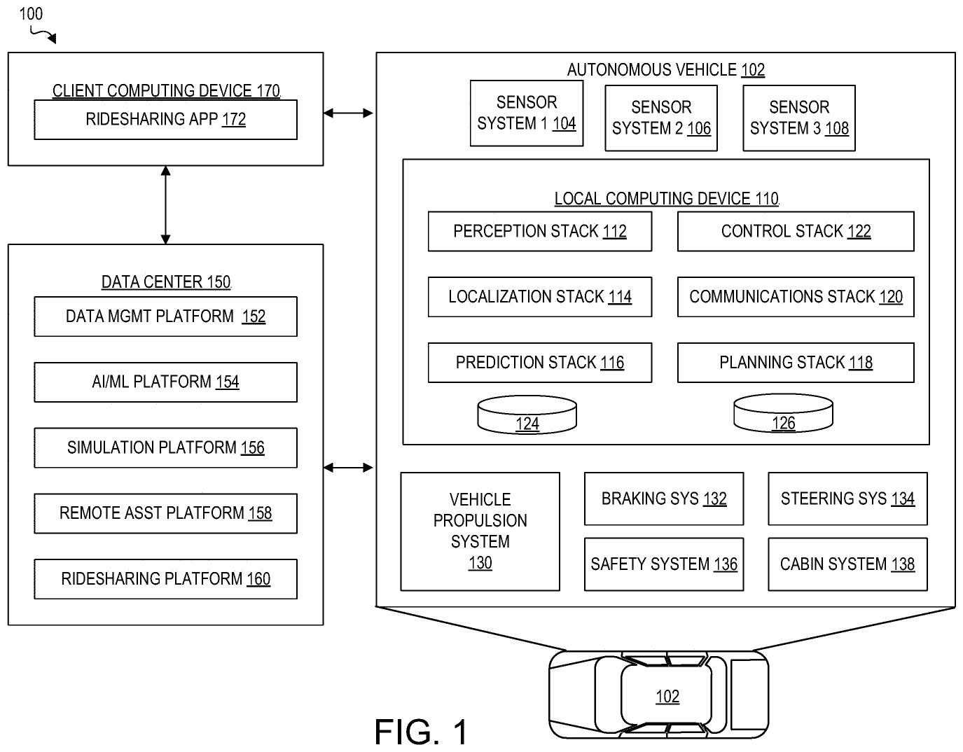

Turning now to the drawings, FIG. 1 illustrates an example of an autonomous vehicle (AV) management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill in the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138. Additionally or alternatively, one or more of the mechanical systems 130-138 of the AV may be controlled via remote interfaces (e.g., external controllers communicating via radio or other networks).

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV 102, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV 102, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV 102 is above a threshold range for turning, and turn left; turn on the right blinker, accelerate if the AV 102 is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, the planning stack 118 could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by the AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high rates of transmission (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

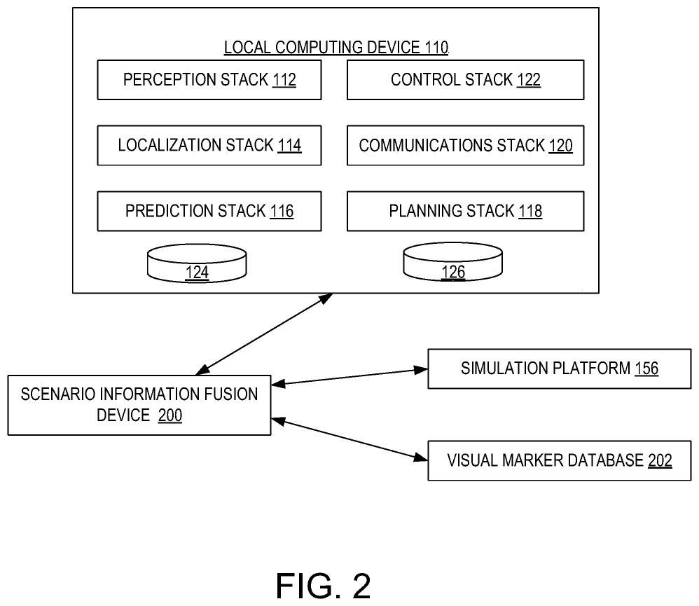

FIG. 2 illustrates an example system for generating hybrid scenario information for use in closed course testing in accordance with one or more embodiments described herein. One of ordinary skill in the art will understand that, for the system shown in FIG. 2, and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill in the art will appreciate that such variations do not depart from the scope of the present disclosure.

In this example, the system includes a local computing device 110 of an AV (e.g., the AV 102), a scenario information fusion device 200, a simulation platform 156, and a perceivable marker database 202. Each of these components is described below.

In one or more embodiments, the local computing device 110, and the components shown therein (i.e., perception stack 112, localization stack 114, prediction stack 116, planning stack 118, communications stack 120, control stack 122, AV operational database 124, and HD geospatial database 126) are part of an AV, and are substantially similar to the like named and numbered components shown in FIG. 1 and discussed above. However, the functionality of all or any portion of these components may be altered in some ways to facilitate hybrid scenario closed course testing. As an example, the perception stack 112 may be configured to recognize certain types of perceivable markers (e.g., QR codes) perceived by sensors of the AV, and to transmit the perceivable marker information to a scenario fusion information device 200. Perception stack 112 may also be further configured to transmit sensor information to the scenario information fusion device. Additionally, all or any portion of the components of local computing device 110 may be configured to receive some or all of the hybrid scenario information generated by the scenario information fusion device 200, such that any of the components of local computing device 110 may respond (e.g., by performing one or more AV control actions) to the hybrid scenario information as if it is real environment information perceived by or otherwise obtained by the AV.

In one or more embodiments, an AV control action is any action that an AV may perform in response to information about the environment (i.e., scenario information) perceived by or otherwise obtained by an AV. Examples include, but are not limited to, decelerating, stopping, accelerating, altering a planned course, communicating with another entity (e.g., a passenger, a datacenter, etc.), engaging a safety system (e.g., turning on a turn signal), etc.

In one or more embodiments, the local computing device 110 is operatively connected to a scenario information fusion device 200. In one or more embodiments, scenario information fusion device 200 is any hardware, software, or combination thereof that is configured to generate hybrid scenario information. In one or more embodiments, hybrid scenario information is a combination of sensor data obtained by an AV, simulated scenario information, and information obtained using perceivable marker information. Hybrid scenario information may be transmitted to the AV in one or more embodiments.

Hybrid scenario information may be transmitted to any one or more components of an AV. As an example, hybrid scenario information may include, at least in part, simulated, altered, or augmented information that appears to be raw sensor data, which may be provided to the localization stack 114, prediction stack 116, planning stack 118, etc. As another example, hybrid scenario information may include, at least in part, already-processed real or simulated data (e.g., geometric footprints of objects), which may be provided to the planning stack 118 of the AV.

In one or more embodiments, simulated scenario information may be received from any source capable of simulating an environment surrounding an AV. For example, simulated scenario information may be received from simulation platform 156 (discussed above in the description of FIG. 1). Simulated scenario information may be all or any part of a scenario of an environment surrounding an AV. For example, simulated scenario information may be all or any part of a simulation of a scenario encountered by an AV while driving. Simulated scenario information may be partly or entirely constructed instead of being based on real-world data. Simulated scenario information may include simulated environment information (e.g., lane boundaries/types, vegetation, etc.) and/or simulated object information (e.g., pedestrians, other vehicles, signs, etc.). Simulated scenario information may be in a form that appears as if it came from one or more sensors of an AV (e.g., LIDAR data, RADAR data, image data, etc.) and/or in a form that such data would appear after processing by one or more components of an AV (e.g., bounding boxes added to the scenario around objects therein). As an example, simulated scenario information may include simulated road markings that differ from any road markings present in a closed course environment in which an AV is being tested. As another example, simulated scenario information may include object information representing a large number of pedestrians in the vicinity of the AV which are not physically present in the closed course environment.

In one or more embodiments, perceivable marker information is any information that may be obtained using a perceivable marker perceived by an AV. In one or more embodiments, a perceivable marker is any marker that can convey information that may be used as a key to obtain different information, and that may be perceived by any sensor of an AV. Examples of perceivable markers include, but are not limited to, QR codes, ultra-violet markers, infrared range images, LIDAR reflective patches, sonic/ultrasonic markers, electromagnetic tags, etc. Additionally or alternatively, perceivable markers may be information communicated from an agent (e.g., a robot, a drone, etc.) in the closed course environment. In one or more embodiments, such perceivable markers may be affixed to agents in the closed course environment, such as aerial drones, wheeled robots, etc. In one or more embodiments, perceivable marker information is received at the scenario information fusion device 200 from an AV, which obtained the perceivable marker information from one or more sensors and processed said information (e.g., via the perception stack 112) to determine that it was, in fact, perceivable marker information.

In one or more embodiments, scenario information fusion device 200 is configured to use the perceivable marker information to perform a lookup in a perceivable marker database 202. In one or more embodiments, perceivable marker database 202 is a data structure of any type that stores data associated with perceivable markers. As an example, scenario information fusion device 200 may receive a QR code perceived by a sensor of an AV and use the information within the QR code to perform a lookup in the perceivable marker database 202 to obtain data associated with the QR code. The data associated with a perceivable marker in perceivable marker database 202 may be data representing an object that is different than the object to which the perceivable marker is affixed.

For example, a wheeled robot may exist in the closed course environment with a perceivable marker affixed. When the AV perceives the perceivable marker, the associated perceivable marker information may be transmitted to scenario information fusion device 200. Scenario information fusion device 200 may then use the perceivable marker information to perform a lookup in the perceivable marker database 202 to obtain the data associated with the perceivable marker. The data may include a representation of a school bus, which the scenario information fusion device 200 may insert into the hybrid scenario information instead of the robot present in the closed course environment that had the perceivable marker attached. Data associated with a perceivable marker in perceivable marker database 202 may represent any object or element that could be present in a scenario encountered by an AV.

In one or more embodiments, the scenario information fusion device 200 is configured with information regarding how to combine the sensor data received from an AV in a closed course environment with simulated scenario information and data associated with one or more perceivable markers perceived by the AV to generate hybrid scenario information. The hybrid scenario information may then be provided to the AV as if the AV were in the hybrid scenario represented by the hybrid scenario information rather than the closed course environment that the AV is in for testing. Thus, embodiments described herein allow for an AV to be tested in a much larger variety of scenarios without having to fully implement such scenarios in a closed course environment. Such testing may include providing the hybrid scenario to any component of the AV, depending on the goals of the test (e.g., testing the prediction stack 116, testing the planning stack 118, end-to-end testing of the software stack, etc.). Such testing, using hybrid scenario information in the physical reality of a closed course environment, may allow for the real-world physics and realities encountered by an AV to be incorporated into the testing, such as, for example, road friction, signal latency within the AV hardware, collisions with physical objects, etc.

The scenario information fusion device 200 may be included in an AV or separate from and operatively connected to an AV. As an example, scenario information fusion device 200 may be implemented as part of a separate computing device within the closed course environment that is in communication with the AV under test. As another example, the scenario information fusion device 200 may be implemented as one or more computing devices in a data center that is in communication with the AV under test in the closed course environment. The perceivable marker database 202 may be part of the same device as the scenario information fusion device 200, may be separate from and operatively connected to the scenario information fusion device 200, may be part of the AV, etc.

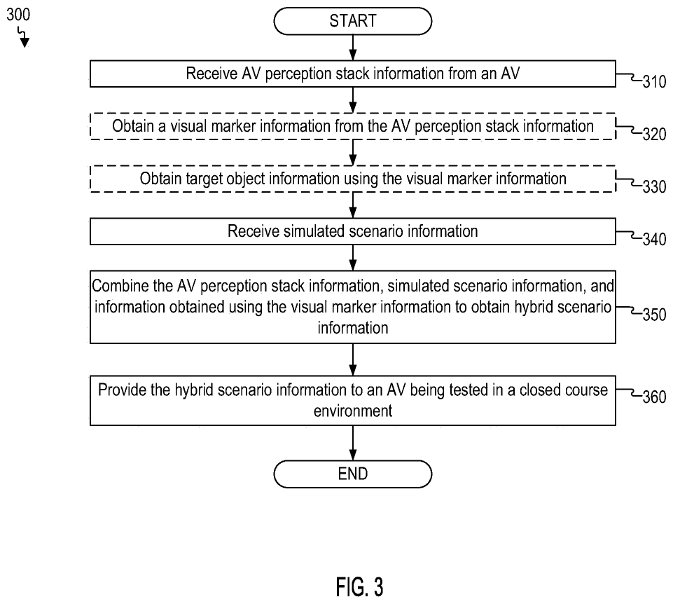

FIG. 3 illustrates an example method 300 for generating hybrid scenario information for testing an AV in a closed course environment. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method includes receiving AV perception stack information from an AV (e.g., the AV 102) at step 310. In one or more embodiments, AV perception stack information includes data obtained by one or more sensors of the AV (i.e., sensor information). AV perception stack information may also include perceivable marker information obtained by the AV from one or more perceivable markers perceived by the AV. As an example, the hybrid information fusion device 200 illustrated in FIG. 2 may receive AV perception stack information from an AV.

According to some embodiments, the method 300 optionally includes obtaining a perceivable marker from the AV perception stack information at step 320. For example, the hybrid information fusion device 200 illustrated in FIG. 2 may obtain a perceivable marker from the AV perception stack information by separating perceivable marker information of one or more perceivable markers perceived by an AV from other sensor data included in the AV perception stack information. In some embodiments, the perceivable marker information is obtained from a perceivable marker attached to a physical object. Examples of perceivable markers include, but are not limited to, QR codes, ultra-violet markers, infrared range images, LIDAR reflective patches, sonic/ultrasonic markers, electromagnetic tags, etc. Additionally or alternatively, perceivable markers may be information communicated from an agent (e.g., a robot, a drone, etc.) in the closed course environment.

According to some embodiments, the method 300 includes optionally performing a lookup using the perceivable marker to obtain target object information at step 330. For example, the hybrid information fusion device 200 illustrated in FIG. 2 may perform a lookup using the perceivable marker and a perceivable marker database to obtain target object information. In some embodiments, the target object information is used to replace the perceivable marker with a target object in the hybrid scenario information.

According to some embodiments, the method 300 includes receiving simulated scenario information at step 340. For example, the hybrid information fusion device 200 illustrated in FIG. 2 may receive simulated scenario information from the simulation platform 156 illustrated in FIG. 1 and/or FIG. 2. In one or more embodiments, simulated scenario information may be received even when no perceivable markers have been perceived by an AV (i.e., simulated scenario information and sensor data from an AV may be obtained for creating hybrid scenario information even in the absence of perceivable markers in the closed course environment). The simulated scenario information may include any information of any type that represents anything that may exist in an environment encountered by an AV. All or any portion of simulated scenario information may be based on real-world data collected by an AV. All or any portion of simulated scenario information may be artificially constructed (i.e., as opposed to being based on real world information). All or any portion of simulated scenario information may be simulated environment information (e.g., road markings, vegetation, etc.). All or any portion of simulated scenario information may be simulated object information (e.g., pedestrians, other vehicles, etc.).

According to some embodiments, the method 300 includes combining the AV perception stack information, the simulated scenario information, and, optionally, information obtained using the perceivable marker information to obtain hybrid scenario information at step 350. For example, the hybrid information fusion device 200 illustrated in FIG. 2 may combine the AV perception stack information, the simulated scenario information, and information obtained using the perceivable marker information to obtain the hybrid scenario information. Hybrid scenario information may be generated pursuant to rules and other information regarding how the various sources of information should be combined. Hybrid scenario information may be generated using compute resources of an AV, using computing devices in communication with the AV, using cloud computing resources, or any combination thereof.

According to some embodiments, the method 300 includes providing the hybrid scenario information to an AV at step 360. For example, the hybrid information fusion device 200 illustrated in FIG. 2 may provide the hybrid scenario information to an AV. All or any portion of the hybrid scenario information may be provided to any component of the AV. As such, all or any portion of the hybrid scenario information may be provided to one or more of a perception stack of an AV, a localization stack of an AV, a prediction stack of an AV, a planning stack of an AV, a communications stack of an AV, a control stack of an AV, etc. As an example, all or any portion of the hybrid scenario information may be provided to the perception stack of the AV so that the perception stack has to process the information of the hybrid scenario represented by the hybrid scenario information (i.e., as opposed to solely processing the data obtained by the sensors of the AV). As another example, the hybrid scenario information may be provided to the AV to alter and/or replace data coming out of the perception stack (e.g., changes to labels on bounding boxes of objects, changes to the size of one or more bounding boxes, changes to the kinematics, trajectory, or pose of one or more objects, etc.). As another example, localization data, map data, etc. may be altered (e.g., road marking changes, road lanes may be added, etc.). In one or more embodiments, regardless of the location in the software stack of the AV where information from the hybrid scenario information is added and/or altered, subsequent portions of the stack (e.g., the prediction stack, the planning stack, the control stack, etc.) consume the information so that the AV may ultimately be controlled appropriately based on the hybrid scenario.

In one or more embodiments, the AV receiving hybrid scenario information reacts to the hybrid scenario information as if it were in an environment represented by the hybrid scenario information, as opposed to reacting only to the real environment present in the closed course in which the AV is being tested. In one or more embodiments, the AV reacts to the hybrid scenario information by performing one or more control actions, such as, for example, decelerating (e.g., by applying the brakes), stopping, changing course, accelerating, turning various signals on or off, etc. In one or more embodiments, the AV reacts to receiving the hybrid scenario information by processing at least a portion of the hybrid scenario information, which may, in turn, lead to one or more AV control actions. For example, the hybrid scenario information may include simulated information representing sensor information (e.g., LIDAR data, image data, etc.) that is received by the prediction stack of the AV, which may process the information to make predictions regarding the future trajectories of objects in the environment represented by the hybrid scenario information. The predicted trajectories may then be consumed by the planning stack of the AV to make decisions regarding which one or more AV control actions to take in order to safely navigate the AV via the control stack of the AV in concert with the various systems of the AV (e.g., vehicle propulsion, braking, safety, steering, cabin, etc.).

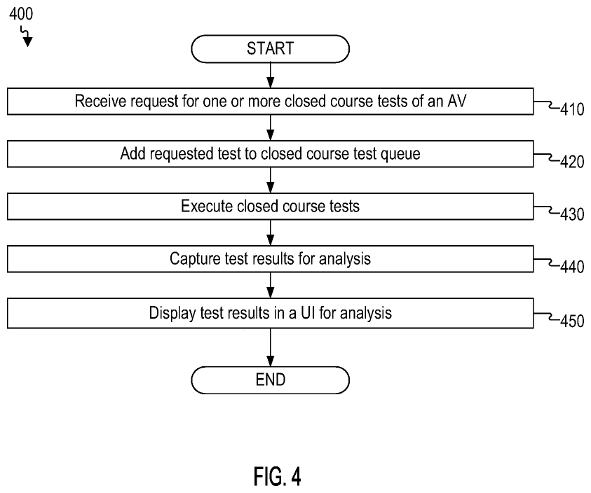

FIG. 4 illustrates an example method 400 for partially or fully automated testing of an AV in a closed course environment using hybrid scenario information in accordance with one or more embodiments described herein. Although the example method 400 depicts a particular sequence of operations, the sequence may be altered without departing from the scope of the present disclosure. For example, some of the operations depicted may be performed in parallel or in a different sequence that does not materially affect the function of the method 400. In some examples, different components of an example device or system that implements the method 400 may perform functions at substantially the same time or in a specific sequence.

According to some embodiments, the method 400 includes receiving a request to perform a test of an AV (e.g., the AV 102) in a closed course environment at step 410. Test requests may originate from an engineer requesting that one or more particular tests be executed. Test requests may be automatically triggered (e.g., in response to a weekly AV software release or update). Requested tests may be selected from among a test scenario bank that includes any number of closed course tests for an AV.

According to some embodiments, the method 400 includes adding the requested test to a queue of test requests for testing an AV in a closed course environment at step 420. A test request may be placed into a queue of such requests to be executed in the closed course environment. A test request may be placed into the queue using any prioritization and/or ranking scheme. As an example, such a placement may be a sequential order in which the requests were received. Additionally or alternatively, test requests may be associated with a priority value, which may determine, at least in part, what position within a requested test queue the test request is placed.

According to some embodiments, the method 400 includes executing the requested test using an AV in a closed course environment at step 430. Executing the test may include setting up the closed course environment. In one or more embodiments, a closed course environment is an environment in which closed course testing may occur. A closed course environment may be, for example, a closed set of roads or other closed environment separated from other roads, environments, external traffic, pedestrians, etc. Examples of setting up the closed course environment may include, but is not limited to, communicating with the AV to be tested to put the AV at a certain position within the closed course environment, communicating with other AVs in the closed course environment to place them in certain positions relative to the AV being tested, communicating with agents (e.g., drones, robots, etc.) in the closed course environment that have perceivable markers attached to position the agents relative to the AV, positioning any other physical objects in the closed course environment relative to the AV being tested, etc. Executing the test may also include receiving simulated scenario information that will be provided to the AV during the test as part of the hybrid scenario information. Executing the test may also include, while the AV is navigating in the closed course environment, receiving sensor information and perceivable marker information from the AV as it perceives the closed course environment and any perceivable markers therein. Executing the test may also include combining the sensor information, simulated scenario information, and information obtained using the perceivable marker information to generate hybrid scenario information. Executing the test may also include providing the hybrid scenario information to one or more components of the AV, thereby altering the AVs perception of the environment in which it is being tested.

According to some embodiments, the method 400 includes capturing the results of the test of the AV in a closed course environment at step 440. Capturing the results may include obtaining data from the AV regarding actions the AV performed in response to the hybrid scenario information. Results of the test may be captured from all or any portion of the components of the AV. Capturing the results may include obtaining data from any other device in the closed course environment (e.g., a video camera) that may be set up to observe the test.

According to some embodiments, the method 400 includes displaying the results of the test of the AV in a closed course environment at step 450. In one or more embodiments, the results may then be analyzed (e.g., by one or more engineers, automated systems, etc.) in order to assess the performance of the AV during the test. In one or more embodiments, the results of the test are displayed in a user interface (UI).

In one or more embodiments, using the above described method, most or all of the testing of an AV in a closed course environment may be automated. Such automation, combined with the hybrid scenario information used during the tests, may allow for improved testing, a greater number of tests being executed per unit time, less time spent setting up scenarios in the closed course environment, and less expenditure for setting up and executing the tests.

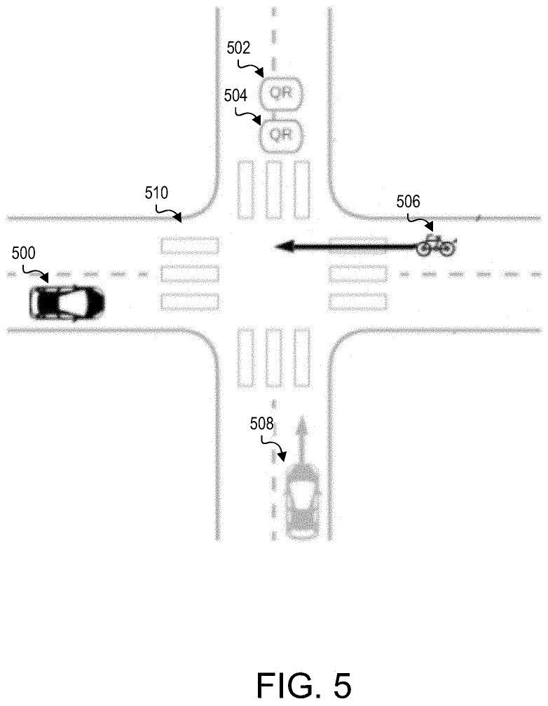

FIG. 5 shows an example of a hybrid scenario used for closed course testing of an AV in accordance with one or more embodiments described herein. The following example is for explanatory purposes only and not intended to limit the scope of embodiments described herein. Additionally, while the example shows certain aspects of embodiments described herein, all possible aspects of such embodiments may not be illustrated in this particular example.

Referring to FIG. 5, consider a scenario in which an AV is to be tested in a closed course environment. In such a scenario, an AV 500 is to be tested. Additionally, a physical bicycle 506 is positioned in the closed course environment and will navigate toward the AV in the opposite lane during the test. Also, a first perceivable marker, QR code 502, and a second perceivable marker, QR code 504, are positioned to the left of the AV on a road intersecting with the road on which the AV is at the start of the test. The test itself is a test of how the AV will react when seeking to make a left turn at the intersection while presented with hybrid scenario information.

When the test execution begins, the AV navigates straight towards the intersection. The road markings 510 shown in FIG. 5 are simulated environment information provided to the AV as part of hybrid scenario information. The other vehicle 508 shown in FIG. 5 is simulated object information provided to the AV as part of hybrid scenario information. The two QR codes 502 and 504 are perceived by the AV, along with the bicycle. The AV transmits its sensor data, including the perception of the bicycle and the QR codes to a scenario information fusion device (not shown). The scenario information fusion device uses the QR code to obtain target object information from a perceivable marker database. In this case, the QR codes translate to barriers preventing vehicles from traveling on the road on which the QR codes exist, which is the road on which the AV is supposed to turn. The scenario information fusion device combines the information representing the barriers, the sensor data from the AV, and simulated scenario information, including simulated road markings 510 and other vehicle 508 to generate hybrid scenario information. The hybrid scenario information is then provided to relevant components of the AV, such that the AV perceives being in the hybrid scenario environment shown in FIG. 5. During the test, the AV will have to account for the simulated other vehicle 508 approaching the intersection, the real bicycle 506 approaching the intersection, and the barriers that replace the QR codes and that prevent the AV from making the intended turn. The correct behavior for the AV in the hybrid scenario environment provided to the AV includes avoiding a collision with real bicycle 506 and other simulated vehicle 508, deducing, based on the barriers that replace the QR codes in the hybrid scenario information that the intended left turn is unavailable, and thus planning an alternate route towards an intended destination. Such behavior may or may not occur during the test. Either way, the results of the test are captured and provided to engineers for analysis.

Another example test (not shown in FIG. 5) may include providing the AV with hybrid scenario information that does not include many surrounding objects. The closed course environment may include another vehicle to create an occlusion zone. During the test, a robot with a perceivable marker attached may move from behind the occlusion zone into the path of the vehicle. A scenario information fusion device may convert the perceivable marker into a pedestrian, which is provided to the AV as part of the hybrid scenario information. The correct behavior of the AV, when presented with this hybrid scenario, is to safely avoid a collision with the pedestrian. Whether or not that behavior occurs, the results of the test are captured for analysis.

The above described test may then be repeated, but this time 100 simulated pedestrians are added to the hybrid scenario information, such that the systems of the AV must now process and account for many more objects, thereby taxing the compute resources of the AV as it attempts to successfully avoid the pedestrian that enters into the path of the AV from behind the occlusion zone.

Similar to the above described test having the additional simulated pedestrians, any number of other variations of tests may be quickly generated and provided to the AV as hybrid scenario information in order to increase the quantity and variety of tests executed, with less time and effort than would be required to physically set up each such variation.

Also, in the above described scenario, using the QR code on a robot to represent a pedestrian alleviates the need to have an actual pedestrian moving into harm's way by jumping into the path of the car.

Further, the above-described closed course testing of an AV may allow for realistic crashes to be tested. On-road crashes (especially severe ones) are relatively rare and undesirable. For example, the AV might have tap sensors whose signals can be hard to model. Using automated closed course testing, different types of crashes can be modeled, simulated, and conducted, particularly to determine the AV reaction to the crashes, and ensuring the AV takes the right course of action during and after a crash. The road actors may be made out of crash dummy materials or other inflatables to prevent equipment damage during this testing.

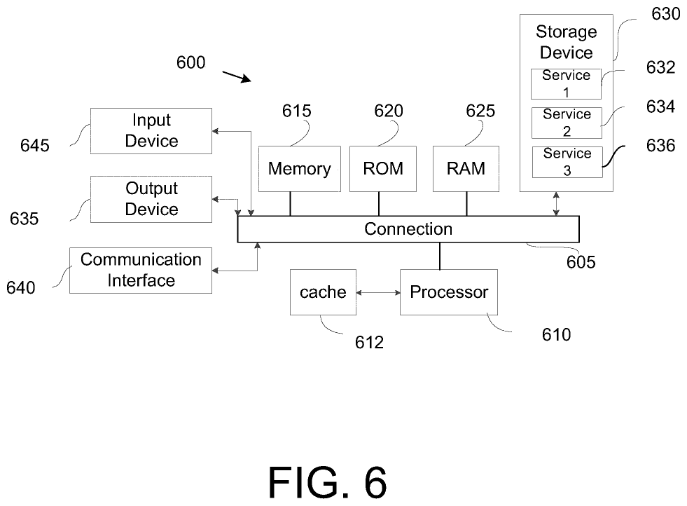

FIG. 6 shows an example of computing system 600, which can be, for example any computing device making up the scenario information fusion device 200 of FIG. 2, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for hybrid scenario closed course testing of autonomous vehicles (AVs), the method comprising:
receiving AV perception stack information from a perception stack of an AV, the AV perception stack information comprising sensor information and perceivable marker information;
receiving simulated scenario information;
combining the AV perception stack information and the simulated scenario information to obtain hybrid scenario information; and
providing the hybrid scenario information to an AV,
wherein the AV processes the hybrid scenario information to perform one or more AV control actions.

2. The method of claim 1, wherein the simulated scenario information comprises simulated environment information.

3. The method of claim 1, wherein the simulated scenario information comprises simulated object information.

4. The method of claim 1, wherein:
the perceivable marker information comprises information obtained from a perceivable marker in a closed course environment,
the perceivable marker is affixed to an agent in the closed course environment that is configured to automatically place the perceivable marker within the closed course environment.

5. The method of claim 4, wherein the providing of the hybrid scenario information to the AV is performed based on an automated test request added to a test queue for testing the AV in a closed course environment.

6. The method of claim 1, wherein combining the AV perception stack information and the simulated scenario information comprises:
obtaining a perceivable marker from the perceivable marker information; and
performing a lookup using the perceivable marker to obtain target object information.

7. The method of claim 6, wherein the target object information is used to replace the perceivable marker with a target object in the hybrid scenario information.

8. The method of claim 1, wherein the sensor information comprises data obtained from sensors of the AV.

9. The method of claim 1, wherein the perceivable marker information is obtained from a perceivable marker attached to a physical object.

10. A non-transitory computer readable medium comprising instructions for hybrid scenario closed course testing of autonomous vehicles (AVs), the instructions, when executed by a computing system, cause the computing system to:
receive AV perception stack information from a perception stack of an AV, the AV perception stack information comprising sensor information and perceivable marker information;
receive simulated scenario information;
combine the AV perception stack information and the simulated scenario information to obtain hybrid scenario information; and
provide the hybrid scenario information to an AV,
wherein the AV processes the hybrid scenario information to perform one or more AV control actions.

11. The non-transitory computer readable medium of claim 10, wherein the simulated scenario information comprises simulated environment information.

12. The non-transitory computer readable medium of claim 10, wherein the simulated scenario information comprises simulated object information.

13. The non-transitory computer readable medium of claim 10, wherein the non-transitory computer readable medium further comprises instructions that, when executed by the computing system, cause the computing system to:
obtain a perceivable marker from the perceivable marker information; and
perform a lookup use the perceivable marker to obtain target object information.

14. The non-transitory computer readable medium of claim 13, wherein the target object information is used to replace the perceivable marker with a target object in the hybrid scenario information.

15. The non-transitory computer readable medium of claim 10, wherein the perceivable marker information is obtained from a perceivable marker attached to a physical object.

16. A system for hybrid scenario closed course testing of autonomous vehicles (AVs), comprising:
a storage configured to store instructions; and
a processor configured to execute the instructions and cause the processor to:
receive AV perception stack information from a perception stack of an AV, the AV perception stack information comprising sensor information and perceivable marker information;
receive simulated scenario information;
combine the AV perception stack information and the simulated scenario information to obtain hybrid scenario information; and
provide the hybrid scenario information to an AV,
wherein the AV processes the hybrid scenario information to perform one or more AV control actions.

17. The system of claim 16, wherein the simulated scenario information comprises simulated environment information and simulated object information.

18. The system of claim 16, wherein the processor is configured to execute the instructions and cause the processor to:
obtain a perceivable marker from the perceivable marker information; and
perform a lookup use the perceivable marker to obtain target object information.

19. The system of claim 18, wherein the target object information is used to replace the perceivable marker with a target object in the hybrid scenario information.

20. The system of claim 16, wherein the perceivable marker information is obtained from a perceivable marker attached to a physical object.
